(19) United States
(12) Patent Application Publication
(10) Pub. No.: US 2012/0166168 A1
(43) Pub. Date: Jun. 28, 2012

(54) METHODS AND SYSTEMS FOR FAULT-TOLERANT POWER ANALYSIS

(75) Inventor: Vijay Srinivasan, San Francisco, CA (US)

(73) Assignee: ORACLE INTERNATIONAL CORPORATION, Redwood City, CA (US)

(21) Appl. No.: 12/978,193

(22) Filed: Dec. 23, 2010

(51) Int. Cl. G06F 17/50

(52) U.S. Cl. 703/14

(57) ABSTRACT

Methods and systems are described which enable a user to conduct a power analysis of a behavior description of a circuit design. The elements of the circuit design are described at the register transfer level and synthesized to a gate-level netlist. Embodiments of the invention allow a user to conduct accurate power analysis during register transfer level to gate-level netlist synthesis.

### FIELD OF THE INVENTION

Aspects of the present invention relate to integrated circuit design. More specifically, aspects of the present invention relate to performing power analysis on a circuit design.

### BACKGROUND

An integrated circuit (“IC”) is created using a complex multiple-step design process. During each step of the design process, the IC design is represented using different levels of specificity and/or abstraction. Additionally, during each step of the design process, different verification and testing processes can be used to ensure the IC design is performing properly. For example, power analysis for the circuit design may be performed. Power analysis predicts the power consumption of an IC by analyzing characteristics of the IC design during simulation.

The circuit design process typically begins with a high-level code description that describes the intended behavior of the IC. Commonly, the high level description is at the register transfer level (“RTL”), and generally referred to as an RTL model. In the RTL model, the circuit functionality is defined in terms of a flow of signals between registers, functional blocks, and other components of the circuit. It is often desirable to perform RTL model power analysis to determine the power consumption level of the RTL model so that optimizations can be made that ensure the final design meets specified power requirements.

Typically, in order to conduct power analysis on an RTL model, the RTL model is synthesized into an intermediate logic level description generally referred to as a gate-level netlist design. The gate-level netlist redefines the RTL model as a set of physical components such as logic gates and clock signals. Power analysis may be conducted using the gate-level netlist representation, as long as the gate-level netlist accurately reflects the RTL model.

However, while the RTL model is being synthesized into a gate-level netlist, there may be mismatches between the RTL model and the corresponding synthesized gate-level netlist, resulting in a gate-level netlist that does not accurately reflect the RTL model. Any power analysis conducted using the inaccurate gate-level netlist may be unreliable. Hence, these mismatches often result in unreliable power analysis of the IC design.

### SUMMARY

According to one aspect, a RTL/Gate Matching application includes modules that are executable by a processor to conduct dynamic power analysis of a circuit. The RTL/Gate Matching application includes a accessing module to access a mapping file from a memory, the mapping file defining a map between a plurality of state nodes in a RTL model of the circuit and a plurality of corresponding state nodes in a gate level net list for the circuit. An identification module identifies a state value at each of the plurality of states nodes in the RTL model for a plurality of cycles. A value setting module applies the state value of each state node in the RTL model to the corresponding state node in the gate level net list during each cycle of the plurality of cycles.

According to another aspect, a system for conducting dynamic power analysis of a circuit includes at least one processor system. The processor system is capable of executing a RTL/Gate Node Matching application to access a mapping file from a memory, the mapping file defining a map between a plurality of state nodes in a RTL model of the circuit and a plurality of corresponding state nodes in a gate level net list for the circuit. The processor system is capable of executing a RTL/Gate Node Matching application to identify a state value at each of the plurality of states nodes in the RTL model for a plurality of cycles. The processor system is capable of executing a RTL/Gate Node Matching application to apply the state value of each state node in the RTL model to the corresponding state node in the gate level net list during each cycle of the plurality of cycles. The processor system is capable of executing a RTL/Gate Node Matching application to determine power data for the gate level net list at the particular point in time, or during each cycle of the plurality of cycles, based on the state values applied to each of the corresponding state nodes.

In another aspect, a method is provided for conducting dynamic power analysis of a circuit. The method includes accessing a mapping file from a memory, the mapping file defining a map between a plurality of state nodes in a RTL model of the circuit and a plurality of corresponding state nodes in a gate level net list for the circuit. The method further includes identifying a state value at each of the plurality of states nodes in the RTL model for a plurality of cycles. The method includes applying the state value of each state node in the RTL model to the corresponding state node in the gate level net list during each cycle of the plurality of cycles. Further, the method provides determining power data at an output of the gate level net list during each cycle of the plurality of cycles based on the state values assigned to each of the corresponding state nodes.

### BRIEF DESCRIPTION OF THE DRAWINGS

FIG. 1 is a block diagram of an example system, for performing dynamic power analysis.

FIG. 2 is a block diagram of an RTL/Gate Matching application according to one aspect of a RTL/Gate Matching system.

FIG. 3 is a flowchart illustrating a method form performing dynamic power analysis.

FIG. 4 is a block diagram of a RTL/Gate Matching application in operation.

### DETAILED DESCRIPTION

Aspects of the present disclosure include methods and systems for performing power analysis for a circuit design. In particular, the methods and systems provide power analysis data that is consistent with an RTL model that was used to design the circuit, despite any mismatches between the RTL model and the corresponding synthesized gate-level netlist. Power analysis is typically conducted at a structural level, and thus, requires transformation of the RTL model into the structural or physical model, such as a gate-level netlist. Once the gate-level netlist has been generated, power analysis may be conducted by applying the RTL model and verification vectors to the gate-level netlist, cycle-by-cycle (value-change by value-change) to toggle all of the nodes, state nodes, and/or internal nodes of the gate-level netlist consistent with the RTL model, allowing for power analysis to be conducted that accurately reflects the RTL model.

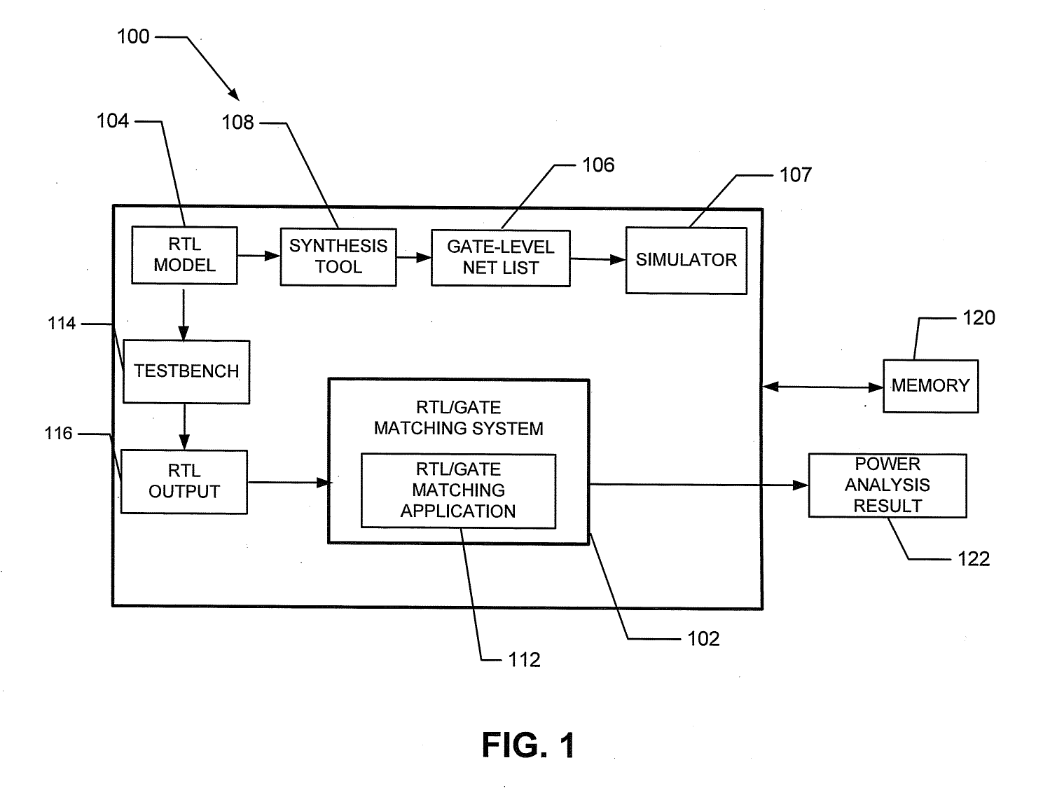

FIG. 1 is system diagram of one possible implementation of a power analysis system (“PAS”) 100. The PAS 100 includes an RTL model 104. RTL model 104 is a high-level specification of a circuit design that describes the desired functionality of the circuit without structural limitations. For example, in some embodiments, the RTL model includes specifications regarding circuit hierarchy, partitioning, clocking scheme, reset scheme, location of registers, etc. In another example, the RTL model may describe the functionality of a circuit using variables and data operators to represent circuit components such as registers and functional blocks.

The RTL model 104 serves as input into a test bench 114. In one embodiment, a test bench refers to a virtual environment used to verify the correctness or soundness of an RTL model or other circuit design or model. In another embodiment, a test bench may include a collection of testing components or tools, specifically designed for the product or design under test. Such testing components may include input and output components, simulators, etc. The test bench used in the PAS 100 could be any standard test bench such as a standalone test bench, a full-chip test bench, or a custom test bench. In one embodiment, the test bench 114 may take as input, RTL model 104 and RTL verification vectors, and pass the inputs to a simulator (a testing component in the test bench environment), which outputs results. In one embodiment, the output results may be in the form of a waveform, an RTL simulation dump, or a value change dump file. In another embodiment, the output results may represent the RTL model's toggle activity. Typically, toggle activity refers to the rate at which a node in an RTL or gate-level netlist may switch up or down, and is usually measured per cycle.

RTL model 104 also serves as input to the synthesis tool 108. Synthesis tool 108 synthesizes the RTL Model 104 to produce the gate-level netlist 106. Synthesis is the process of generating the gate-level netlist from an RTL model. RTL models can be repeatedly synthesized into a gate-level netlist as timing, noise, and other electrical/physical characteristics of the gate-level netlist perform desired behaviors and satisfy required specifications, such as meeting specific power consumption levels. Synthesis may be performed by any suitable external synthesis software tool. While the test bench 114 and the synthesis tool 108 are shown as part of the power analysis system, these and other components may be physically separate (e.g., running on separate computing systems) and accessible over some form of communication medium, such as a network connection.

A gate-level netlist is a representation of a circuit design at the physical and structural level. A gate-level netlist may be classified as hierarchical or flat, and is defined as a set of interconnecting logic gates or elements. For example, the logic gates may include: AND, NAND, NOR, OR, XOR, NXOR, etc. Additionally, the gate-level netlist may include other circuit elements. In one embodiment, memory elements such as flip-flops and latches may also be included. In one aspect, the netlist is a map in which the ports of individual elements in the netlist are connected to the ports of other elements by the use of nodes. Nodes represent a connection between netlist elements.

Once a gate-level netlist has been synthesized, the gate-level netlist can be verified using gate-level logic simulation. Gate-level logic simulation simulates the operation of the gate-level netlist to verify that the netlist logic accurately represents the RTL model used to synthesize the gate-level netlist. In one embodiment, during gate-level netlist simulation, power analysis can be conducted.

During these early stages of RTL model to gate-level netlist synthesis, RTL designers may be able to identify downstream problems in the RTL model relating to timing, signals, design integrity and reliability. Further, in accordance with aspects of the present disclosure, accurate power analysis also may be performed. Power analysis at the time of gate-level netlist simulation provides an easier opportunity for making power related design changes. For example, in one embodiment, high-impact, power related RTL changes can be made such as adding clock-gating logic and related opportunities. In another embodiment, early power analysis can help an RTL designer quickly explore different architectures, such as replacing large memories with smaller memories.

Typically, the output from passing an RTL model to a test bench, such as RTL output 116, is applied to the primary input pins of a gate-level netlist, cycle-by-cycle, to toggle all the internal gate-level nodes of the gate-level netlist. Assuming that the gate-level netlist is an exact match with the RTL model, the output results of the RTL model applied to gate-level netlist will propagate downstream through the entire gate-level netlist, toggling all of the internal gate-level netlist nodes, state nodes, logic cones, etc, consistent with the RTL model. Subsequently the gate-level netlist toggle activity of the gate-level netlist may then be extracted per cycle and used to perform power analysis, such as transient or dynamic power analysis (one output result is a power/current waveform), that accurately reflects the RTL model. Dynamic power analysis in circuit design typically refers to analyzing power consumption that is due to current drawn from a supply when transistor and wire capacitances switch (charge/discharge) during the circuit's active operation (this is also sometimes called “dynamic” current vs. static current which is due to circuit transistor leakage independent of activity). Transient power analysis refers to a dynamic power analysis when the circuit is switching and the current/power transient needs to be analyzed. A “current transient” plotting a chip's current against real-time may be a typical output of dynamic or transient power analysis.

However, sometimes mismatches may exist between the RTL model and the corresponding synthesized gate-level netlist. Mismatches can arise for a variety of reasons. For example, an RTL designer may continuously test the RTL model, focusing on different functionalities, parameters, and aspects of the RTL model during each test. To supplement the testing, the designer may temporarily place dummy/empty behavioral description placeholders into the RTL model temporarily. Since the behavioral placeholder is not described in actual RTL primitive language, it is not synthesizable. Thus, if the RTL model, with multiple dummy/empty behavioral placeholders, is synthesized into a gate-level netlist, the portions of the gate-level netlist that correspond to the dummy/empty behavioral placeholders in the RTL model will not function properly, resulting in a mismatch. These mismatches may propagate throughout the entire gate-level netlist both physically and in time. Alternatively, an RTL designer may intentionally force state nodes in the RTL model to get the RTL model to function properly. Generally, an RTL designer forces the state nodes of an RTL model when some of the functionality of the RTL model has not been fully implemented. Also, empty/dummy behavioral placeholders may be temporarily placed into the RTL Model to work around the unimplemented logic. In either case, an RTL designer may also alter the RTL model database used to simulate the RTL model without updating such changes in the database used to generate the gate-level netlist, causing a mismatch between the RTL design and gate-level netlist. The RTL database may be a general repository of data including but not limited to RTL verification vector data, RTL Model design data, and RTL Model simulation data. In another embodiment, there may be early stage mismatches outside a logical equivalency check such as race conditions. Many other reasons can be contemplated that would result in mismatches between the RTL model and the synthesized gate-level netlist. Any of these reasons may create mismatches between the RTL Model and the gate-level netlist.

Thus, although the synthesized gate-level netlist is intended to exactly match the RTL model, with regard to logic and connectivity, small ongoing design changes and mismatches may result in less than an exact match between the RTL model and the gate-level netlist. These design changes and mismatches may cause any power analysis conducted using the gate-level netlist to be inaccurate. In one embodiment, the mismatches may stop the gate-level netlist primary input pin toggle activity from propagating through the internal gate-level nodes, logic, cones, etc., resulting in gate-level netlist simulation activity that is inconsistent with the RTL model. Moreover, the mismatches may propagate both downstream physically through the entire gate-level netlist and downstream with regard to time, resulting gate-level netlist output that further diverges from the RTL model. Thus, while the resulting output of the gate-level netlist may be used as a basis for power analysis, the results are often inaccurate and unreflective of the RTL model.

Referring again to FIG. 1, the RGM system 102 allows for accurate power analysis regardless of whether there are mismatches between the RTL model and the gate-level netlist. According to one aspect, the RGM system 102 executes an RGM application 112 to perform a power analysis. In one embodiment, the RGM system 102 may allow for a power analysis to be conducted even before initial logical equivalency checks (a checking process to formally prove that two representations of a circuit design exhibit exactly the same behavior) are conducted and running clean. In another embodiment, the power analysis is performed using the RTL model and verification vectors running over a million cycles or more.

The RGM 112 provides a mapping of state nodes in the RTL model 104 to state nodes in the gate-level netlist 106. A state node is a node which can retain a state at a certain time independent of changing and/or absent inputs that control the node. In another aspect, a state node is a node that can retain its logic value even in the absence of any input directly driving the node. Additionally, the RGM 112 provides for the identification of values from the state nodes in the RTL model 104, cycle-by-cycle, from the RTL output 116. Subsequently, the RGM 112 enables the continuous assignment and/or forcing of the identified state node values to corresponding state nodes in the gate-level netlist 106 as defined by the mapping.

In another embodiment, the RGM 112 may provide a mapping of flops and clock headers in the RTL model 104 to corresponding flops and clock headers in the gate-level netlist 106 based on the state node mappings. Subsequently, the RGM 112 may provide the assignment and/or forcing of gate-level netlist 106 flop and clock header values using the values identified from corresponding RTL flops and clock headers as defined by the mapping. For example, the state nodes inside an RTL may be nodes inside an RTL flop and/or inside an RTL clock header. Thus, the mapping of state nodes in the RTL model 104 to corresponding state nodes in gate-level netlist 106 may allow for the identification of flops and/or clock headers in the RTL model 104 that correspond to flop and/or clock headers in the gate-level netlist 106 using the state node that is common (the state node is identified from the mapping) to both the flop and/or clock header in the RTL model 104 and the gate-level netlist 106. For example, if a.b.c.q (RTL statenode)=a_b_c.q (Gate statenode), where “a.b.c” indicates a 3-level hierarchy and “q” is the specific flop statenode in the RTL/Gate netlist, the RTL flop named “a.b.c” is mapped to the gate-level netlist flop “a_b_c”. Once mapped, the “q” state pin, “d” data pin, and “clk” clock pin, of the gate flop can also be mapped to the corresponding RTL flop “q”, “d”, and “clk” pins. Subsequently, the RTL flop “q”, “d”, and “clk” pin values may be forced cycle-by-cycle (or value-by-value) on to the gate-level netlist flop “q”, “d”, and “clk” pins. The RGM 112 may further provide the identification of values from the RTL flops and clock headers cycle-by-cycle. For example, clock values may be identified that represent the input/output clock values for each clock header. Alternatively, flop values may be identified that equal data/clock and state values per flop. The same example may be applied to identify clock headers in the RTL model 104 that correspond to clock headers in the gate-level netlist 106 and subsequently force the input and output “clk” pins for a clock header in the gate-level netlist 106 with values identified from corresponding clock headers in the RTL model 104.

In yet another embodiment, the RGM 112 may enable the mapping of wires in the RTL model 104 to corresponding wires in the gate-level netlist 106. For example, the wires may be mapped based on a naming convention. The RGM 112 identifies values from the mapped wires cycle-by-cycle. Once the wires have been mapped and values identified, the RGM 112 provides cycle-by-cycle assignment and/or forcing of the identified wire values from the RTL wires to corresponding wires in the gate-level netlist 106 as defined by the mapping.

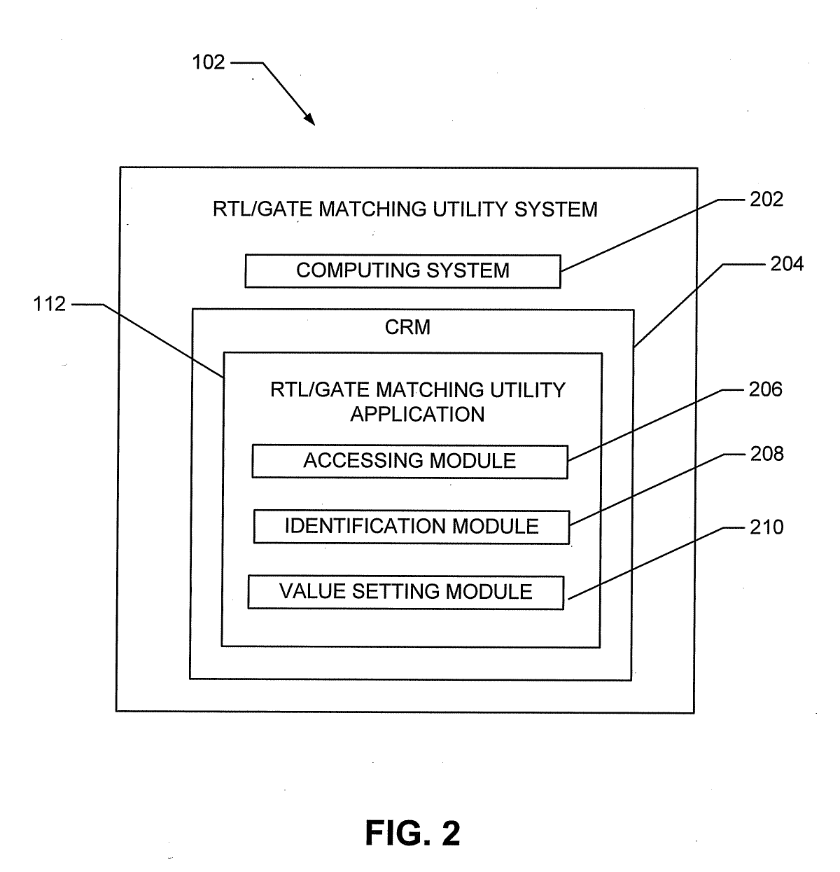

Referring to FIG. 2, the RGM system 102 may include a computing system 202 with a processor that executes the RGM application 112 to perform power analysis. The computing system 202 includes memory, such as a cache memory, RAM, ROM, one or more databases, and the like, included with, coupled with, or otherwise in communication with the processor, as well as other computing components, and may reside on a computer, or other processing system.

In a more particular example, the RGM system 102 includes a computer readable media (“CRM”) 204 configured with the RGM application 112. For example, CRM 204 may include memory, volatile media, nonvolatile media, removable media, non-removable media and/or another available memory that can be accessed by the RGM system 102 or other component of the PAS 100. By way of example and not limitation, computer readable media 204 may include computer storage media. Computer storage media may include memory implemented in a method or technology for storage of information, such as computer readable instructions, data structures, program modules, or other data. Typically, modules include or are implemented by routines, programs, objects, components, data structures, etc. that perform particular tasks or implement particular abstract data types.

The RGM application 112 includes instructions or modules that are executable by the computing system 202. For example, in one embodiment, the RGM application 112 includes an accessing module 206, an identification module 208, and a value-setting module 210. Other modules may also be included.

The accessing module 206 accesses a mapping file from an external source, which associates (i.e., maps) a plurality of state nodes in an RTL Model to a corresponding plurality of state nodes in a gate-level netlist. Mapping is a technique that efficiently establishes a correspondence between state nodes in an RTL model and state nodes in a gate-level netlist. In one embodiment, a naming rule may be used to generate the mapping file. For example, a naming rule may assume that the names of the state nodes and/or wires in an RTL model are preserved during synthesis, and therefore, the names of the state nodes and/or wires in the resulting gate-level netlist, will be the same as in the initial RTL model. In another example, the state nodes in an RTL model may be mapped to the state nodes in a gate-level netlist using a logical equivalency check “Keypoint” mapping file that maps all gate/flop latch instances to the RTL state nodes based on name, logic cone structure, or other algorithms. For example, as a result of running logical equivalency checks, a Keypoint mapping file may be generated. In yet another embodiment, the accessing module may generate a mapping file between the RTL model and the gate-level netlist based on a hierarchical name structure. Once a mapping file has been generated, the mapping may be used to generate forcefiles for flops and clock headers that force gate-level netlist “q”, “d”, and “clk” pins.

In addition accessing or generating a mapping of RTL model state nodes to gate-level netlist state nodes, the accessing module may access or generate a mapping of RTL wires to gate-level netlist wires. In yet another embodiment, the mapping file may be used to map RTL flops and RTL clock headers to gate-level netlist flops and clock headers. Once the wires and/or clock headers have been mapped, data/clock pins in the gate-level netlist may be forced based on the mapped clock headers and pin of the flops in the gate-level netlist may be forced based on the mapped gate-level netlist flops. A single mapping file may define a mapping of RTL state nodes, wires, flops, and clock headers to corresponding gate-level netlist state nodes, wires, flops, and clock headers. In other embodiments, multiple mapping files may be used.

The identification module 208 accesses an RTL test bench output to identify a state node value for a portion, or all, of the state nodes in an RTL model. For example, the identification module 208 may access an RTL output 116 to identify the values of the RTL model state nodes. Generally, a state is a unique configuration of information in a program or machine at a particular time. A node generally refers to any point on a circuit where two or more circuit elements meet. Thus, a state node is a unique configuration of information at a particular time at a node. In some embodiments, the identified state node values may represent the toggle activity for the state nodes.

The value setting module 210 sets the state nodes in the gate-level netlist. For example, during a particular cycle, a state node in the gate-level netlist will be assigned a state node value that was identified by the identification module 208 from a corresponding RTL model state node, as defined by the mapping accessed by the accessing module 206. The assigning or setting of values in a gate-level netlist may generally be referred to as forcing or slamming the gate-level netlist. In one embodiment, the mapping file may be used to generate a “forcefile” representing the values to be forced onto the statenodes, clock headers, flops, and wires in the gate-level netlist. Subsequently, the forcefile may be used in conjunction with a commercial gate-level netlist simulator to force the state nodes, clock headers, flops, etc., with the identified values.

As a result of forcing or slamming the gate-level netlist, all of the state nodes in the gate-level netlist will be consistent with the RTL model and verification vectors. Further, the toggle activity of the forces state nodes will propagate downstream through the entire gate-level netlist, toggling any remaining un-mapped gate-level state nodes, logic cells, etc., resulting in gate-level structural toggle activity that would be largely consistent with the RTL model. Any mismatches would be limited only to the specific location of the mismatch. For example, after an incorrectly simulating state node is mapped and forced consistent with the RTL model, value-change by value-change (cycle-by-cycle), the mismatch is limited to that state node and does not propagate physically through the rest of the gate-level netlist and in time. Thus, despite any mismatches, almost all of the state nodes in the gate-level netlist would be toggled in the same way as the state nodes would have toggled if the RTL model matched the gate-level netlist, resulting in a gate-level netlist structure, connectivity, and topology that is largely consistent with the RTL model.

The substantial consistency between the RTL model and the gate-level netlist may allow for accurate power analysis since gate-level power analysis only needs to identify overall and total gate-level toggle activity per cycle, or cycle-by-cycle (value-change by value change). Thus, as long as the mismatches, which cause incorrect gate-level toggles, only represent a small fraction of the overall gate-level toggle activity, accurate power analysis can be conducted and power data output can be obtained from the gate-level netlist that reflects the RTL model and verification vector characteristics. For example, the power data output may be a waveform, such as a power or current waveform. Inaccuracies in the power analysis data would be limited and localized only to the state nodes where mismatches occurred. Finally, the power output data may be used to identify large Gate-level power trends very early in the circuit design cycle, when high-impact power related changes to an RTL model can easily be made.

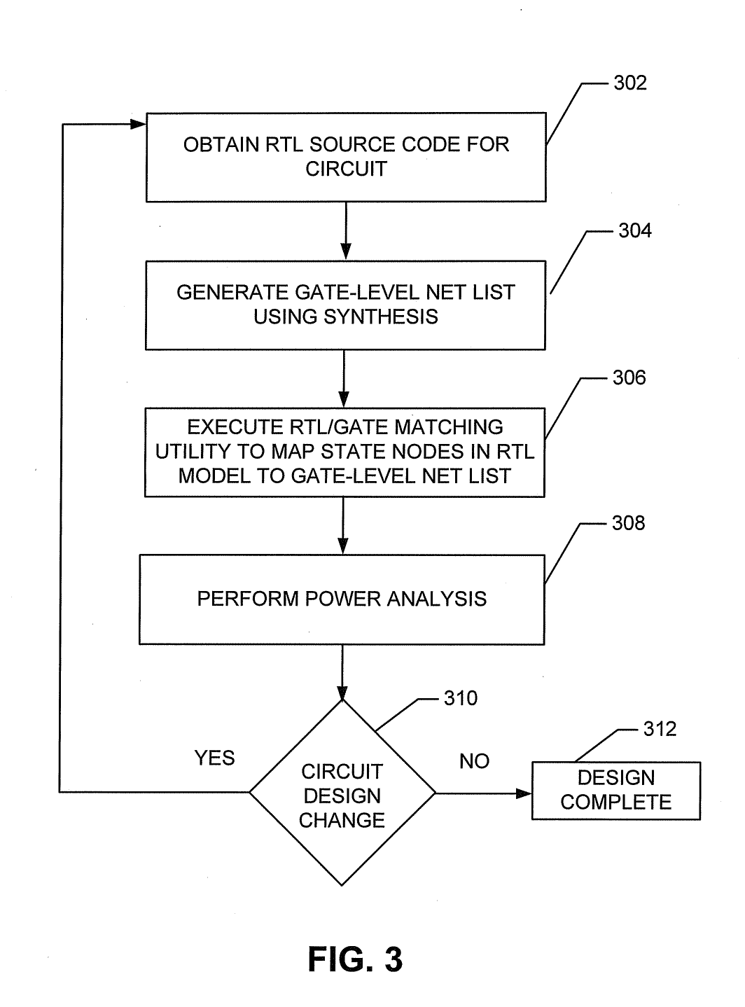

FIG. 3 depicts a method for conducting power analysis according to an example embodiment. At block 302, an RTL model is developed or otherwise obtained for a circuit design. The RTL Model is synthesized to generate a gate-level netlist at block 304. At block 306, a RGM application is executed to update the values in the gate-level netlist with values corresponding to the values of the state nodes in the RTL Model. At 308, power analysis is performed using the gate-level netlist. Power analysis provides an easier opportunity for making power related design changes to the RTL model. For example, high impact clock-gating opportunities may be identified. In one aspect, clock-gating refers to a power-saving technique used with circuits. To save power, clock gating may be implemented to disable portions of the circuit, such as flip-flops, so that circuit components do not change state. Since the circuit components are disabled, their switching power consumption goes to zero, resulting in overall lower power consumption. At block 310, it is determined whether a design change is needed. If a design change is needed, at 310, a new RTL model may again be developed or otherwise obtained for a circuit design at block 302. If it is determined that a design change is not needed, the design is complete at block 312.

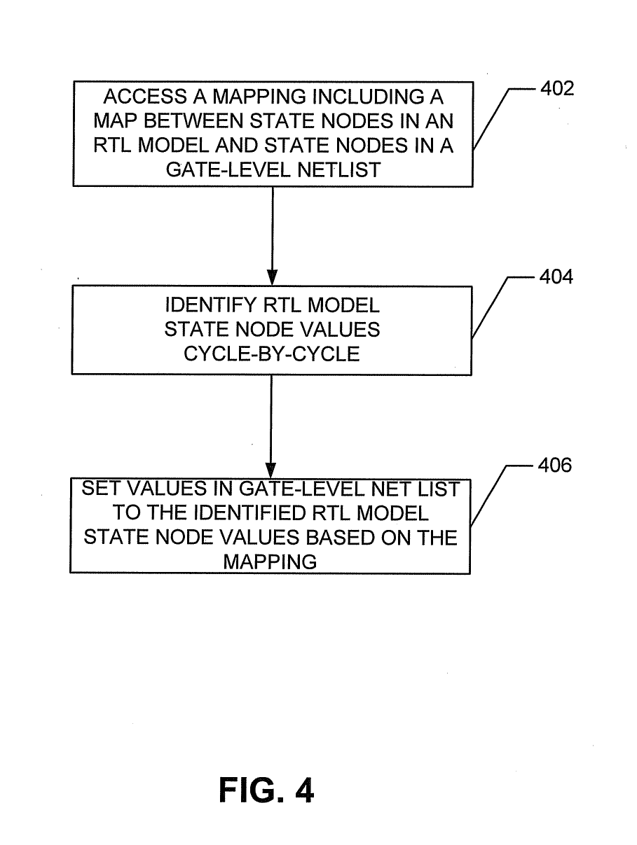

FIG. 4 depicts the RGM application 112 during execution. At 402, the RGM application 112 accesses a mapping file from the memory. RGM application 112 identifies a state value at each of the plurality of states nodes in the RTL model cycle-by-cycle at 404. At 406, RGM application 112 assigns the identified state node values of the state nodes in the RTL Model to a corresponding state node in a gate-level netlist. Once the gate-level netlist state nodes have been updated, power analysis is conducted using the updated gate-level netlist.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A method for conducting integrated circuit design power analysis comprising:
accessing a mapping file from a memory, the mapping file including a map between a plurality of state nodes in a RTL model of a circuit and a plurality of corresponding state nodes in a gate level net list for the circuit;
identifying a state value at each of the plurality of states nodes in the RTL model for a plurality of cycles;
applying the state value of each state node in the RTL model to the corresponding state node in the gate level net list during each cycle of the plurality of cycles; and
determining power data at an output of the gate level net list for each cycle of the plurality of cycles based on the state values assigned to each of the corresponding state nodes.

2. The method of claim 1, wherein the mapping file further includes an additional map between a plurality of wires in the RTL model of the circuit and a plurality of corresponding wires in the gate-level netlist, the method further comprising:
identifying a wire value at each of the plurality of wires in the RTL model for the plurality of cycles;
applying the wire value of each wire in the RTL model to the corresponding wire in the gate level net list during each cycle of the plurality of cycles; and
wherein the determining the power data at the output of the gate level net list for each cycle of the plurality of cycles is further based on the state values assigned to each of the corresponding state nodes and the wire values assigned to each of the corresponding wires.

3. The method of claim 1, wherein the map further identifies a plurality of clock headers in the RTL model of the circuit and a plurality of corresponding clock headers in the gate-level netlist, the method further comprising:
identifying a clock value at each of the plurality of clock headers in the RTL model for the plurality of cycles;
applying the clock value of each clock header in the RTL model to the corresponding clock header in the gate level net list during each cycle of the plurality of cycles; and
wherein the determining the power data at the output of the gate level net list for each cycle of the plurality of cycles is further based on the state values assigned to each of the corresponding state nodes and the clock values assigned to each of the corresponding clock headers.

4. The method of claim 3, wherein the identifying a clock value at each of the plurality of clock headers in the RTL model for the plurality of cycles further comprises:
generating a force file comprising the flop values to be applied to each flop for the plurality of flops in the gate-level netlist based on the map.

5. The method of claim 1, wherein the map further identifies an a plurality of flops in the RTL model of the circuit and a plurality of corresponding flops in the gate-level netlist, the method further comprising:
identifying a value at each of the plurality of flops in the RTL model for the plurality of cycles;
applying the value of each flop in the RTL model to the corresponding flop in the gate level net list during each cycle of the plurality of cycles; and
wherein the determining the power data at the output of the gate level net list for each cycle of the plurality of cycles is further based on the state values assigned to each of the corresponding state nodes and the values assigned to each of the corresponding flops.

6. The method of claim 5, wherein the identifying a value at each of the plurality of flops in the RTL model for the plurality of cycles further comprises:
generating a force file comprising the flop values to be applied to each flop for the plurality of flops in the gate-level netlist based on the map.

7. The method of claim 1, wherein the mapping file is a Keypoint mapping file.

8. The method of claim 1, wherein the mapping file is generated based on a customized naming rule.

9. The method of claim 1, wherein determining the power data at the output of the gate-level netlist for each cycle of the plurality of cycles based on the state values assigned to each of the corresponding state nodes further comprises conducting a transient power analysis using the power data.

10. The method of claim 1, wherein determining the power data at the output of the gate-level netlist for each cycle of the plurality of cycles based on the state values assigned to each of the corresponding state nodes further comprises conducting a dynamic power analysis using the power data.

11. The method of claim 1 further comprising:
identifying overall gate-level power trends for the RTL model based on the power data.

12. A system for conducting power analysis of a circuit, the system comprising:
at least one processor;
an RTL/Gate node matching application executable by the at least one processor to:
access a mapping file from a memory, the mapping file defining a map between a plurality of state nodes in a RTL model of the circuit and a plurality of corresponding state nodes in a gate level net list for the circuit;
identify a state value at each of the plurality of states nodes in the RTL model for a plurality of cycles;
apply the state value of each state node in the RTL model to the corresponding state node in the gate level net list during each cycle of the plurality of cycles; and
determine power data at an output of the gate level net list for each cycle of the plurality of cycles based on the state values assigned to each of the corresponding state nodes.

13. The system of claim 12, wherein the mapping file further includes an additional map between a plurality of wires in the RTL model of the circuit and a plurality of corresponding wires in the gate-level netlist, and wherein the RTL/Gate node matching application executable by the processor is further configured to:
identify a wire value at each of the plurality of wires in the RTL model for the plurality of cycles;
apply the wire value of each wire in the RTL model to the corresponding wire in the gate level net list during each cycle of the plurality of cycles; and
wherein the determination of the power data at the output of the gate level net list for each cycle of the plurality of cycles is further based on the state values assigned to each of the corresponding state nodes and the wire values assigned to each of the corresponding wires.

14. The system of claim 12, wherein the map further identifies a plurality of clock headers in the RTL model of the circuit and a plurality of corresponding clock headers in the gate-level netlist, and wherein the RTL/Gate node matching application executable by the processor is further configured to:
identify a clock value at each of the plurality of clock headers in the RTL model for the plurality of cycles;
apply the clock value of each clock header in the RTL model to the corresponding clock header in the gate level net list during each cycle of the plurality of cycles; and
wherein the determination of the power data at the output of the gate level net list for each cycle of the plurality of cycles is based on the state values assigned to each of the corresponding state nodes and the clock values assigned to each of the corresponding clock headers.

15. The system of claim 14, wherein RTL/Gate node matching application executable by the processor is further configured to:
generate a force file based on the mapping file, to identify the clock value at each of the plurality of clock headers in the RTL model for the plurality of cycles.

16. The system of claim 12, wherein the map further includes an a plurality of flops in the RTL model of the circuit and a plurality of corresponding flops in the gate-level netlist, and wherein the RTL/Gate node matching application executable by the processor is further configured to:
identify a flop value at each of the plurality of flops in the RTL model for the plurality of cycles;
apply the flop value of each wire in the RTL model to the corresponding flop in the gate level net list during each cycle of the plurality of cycles; and
wherein the determination of the power data at the output of the gate level net list for each cycle of the plurality of cycles is further based on the state values assigned to each of the corresponding state nodes and the flop values assigned to each of the corresponding flops.

17. The system of claim 16, wherein the RTL/Gate node matching application executable by the processor is further configured to:
generate a force file based on the mapping file, to identify the flop value at each of the plurality of clock headers in the RTL model for the plurality of cycles.

18. The system of claim 12, wherein the mapping file is a Keypoint mapping file.

19. The system of claim 12, wherein the RTL/Gate node matching application executable by the processor is further configured to:
identify overall gate-level power trends for the RTL model based on the power data.

20. A computer-readable medium encoded with a RTL/Gate node matching application comprising modules executable by a processor and configured to conduct power analysis of a circuit, comprising:
an accessing module to access a mapping file from a memory, the mapping file defining a map between a plurality of state nodes in a RTL model of the circuit and a plurality of corresponding state nodes in a gate level net list for the circuit;
an identification module to identify a state value at each of the plurality of states nodes in the RTL model for a plurality of cycles; and
a value setting module to assign the state value of each state node in the RTL model to the corresponding state node in the gate level netlist during each cycle of the plurality of cycles.
